(19) United States
(12) Patent Application Publication
(10) Pub. No.: US 2011/0191016 A1
(43) Pub. Date: Aug. 4, 2011

(54) MAP DATA, STORAGE MEDIUM AND NAVIGATION APPARATUS

(75) Inventors: Tadao NOMURA, Anjo-city (JP); Takayuki Matsunaga, Hachioji-city (JP)

(73) Assignee: DENSO CORPORATION, Kariya-city (JP)

(21) Appl. No.: 13/013,846

(22) Filed: Jan. 26, 2011

(30) Foreign Application Priority Data
Jan. 29, 2010 (JP) 2010-19099

(51) Int. Cl. G01C 21/26; G06F 17/30

(52) U.S. Cl. 701/200; 707/821; 707/E17.01

(57) ABSTRACT

Map data is disclosed. The map data includes a multilink information list, a road information list and an offset information list. The multilink information list stores fixed-length multilink information elements while multilinks are prescribed in such manner that when groups of links have the same attribute, the groups are collectively defined as a same multilink. Each multilink information element indicates a number of links contained in a corresponding multilink. The road information list stores therein road information elements each indicative of road information of a corresponding multilinks. The offset information list stores therein fixed-length offset information elements each indicative of location of a corresponding road information elements in the road information.

### CROSS REFERENCE TO RELATED APPLICATION

The present application is based on and claims priority to Japanese Patent Application No. 2010-19099 filed on Jan. 29, 2010, disclosure of which is incorporated herein by reference.

### BACKGROUND OF THE INVENTION

1. Field of the Invention

The present invention relates to map data for a navigation apparatus, a computer readable storage medium storing map data, and a navigation apparatus having map data.

2. Description of Related Art

A KIWI/A format is generally used in Japan as a map data format for a navigation apparatus (see Denso technical review, vol. 6, no. 1, 2001, pp. 29-34, for example). In the KIWI/A format, roads on a map are expressed in units of link, and each link has start node reference information and end node reference information. The map data in the KIWI/A format is hierarchized into multiple levels in order to speed up route retrieval etc. A link ID acting as identification information is assigned to each link in the lowest level. In particular, for purpose of efficient drawing of roads with the same attribute and data compression etc., a group of links that are continuously connected with each other and that have the same attribute is defined as a multilink. Link IDs having consecutive values are assigned to the group of links that forms a multilink. When a multilink is expressed in an upper level, links between a start point and an end point of the multiple can be identified based on a link ID of a link corresponding to the start point of the multilink and a link ID of a link corresponding to the end point of the multilink.

A map data format such as the KIWI/A format and the like is optimized for an application that separates and individually utilizes route retrieval data and map drawing data, so that a system can have enhanced accessibility and a short processing time.

In a generally-used map format such as the KIWI/A format and the like, links are organized into multilinks in such manner that a group of links that are continuously connected with each other and that have the same attribute is defined as a multilink in order to facilitate processing. When multiple groups of continuous links have the same attribute and when the multiple groups are spaced apart, multiple multilinks are respectively defined as corresponding to the multiple groups of links.

In the above-described map format, since the groups of links that have the same attribute and that are spaced apart are respectively defined as different multilinks, extraction of all links having the same attribute requires extracting the one multilink at one location and then searching another location for another multilink (see FIG. 3B).

### SUMMARY OF THE INVENTION

The present invention is made in view of the foregoing. It is an objective of the present invention to provide map data for a navigation apparatus, the map data enabling high speed access to data. It is also an objective of the present invention to provide a computer readable storage medium and a navigation apparatus.

According to a first aspect of the present invention, map data is provided. In the map data, roads are expressed in units of link and multilinks are defined based on respective groups of continuous links, multilinks in each group having a same attribute. The map data includes a multilink information list, a road information list, and an offset information list. The multilink information list stores therein fixed-length multilink information elements which respectively corresponds to the multilinks while the multilinks are prescribed in such manner that when one of the groups of links and another one of the groups of links have the same attribute, the one of the groups and the another one of the groups are collectively defined as a same multilink. Each of the multilink information elements indicates a number of links contained in a corresponding one of the multilinks. The multilink information elements are arranged in the multilink information list in a multilink storage order. The road information list stores therein road information elements which respectively correspond to the multilink information elements and which respectively corresponds to the multilinks in such manner that each of the road information elements indicates road information of a corresponding one of the multilinks, wherein the road information elements are arranged in the road information list in an order in which the corresponding multilink information elements are arranged in the multilink information list. The offset information list stores therein fixed-length offset information elements which respectively correspond to the multilink information elements and which respectively correspond to the road information elements in such manner that each of the offset information elements indicates location of a corresponding one of the road information elements in the road information list, wherein the offset information elements are arranged in the offset information list in an order in which the corresponding multilink information elements are arranged in the multilink information list.

In the above map data, the attribute may be road name, road number, road type, road width or the like. According to the above map data, links having the same attribute are collectively defined as a same multilink so as not to be arranged at separate locations. Thus, in extracting links having the same attribute, it is not necessary to search another location after one multilink at one location is extracted. Therefore, the map data enables high speed access to data.

### BRIEF DESCRIPTION OF THE DRAWINGS

The above and other objects, features and advantages of the present invention will become more apparent from the following detailed description made with reference to the accompanying drawings. In the drawings:

FIG. 1 is a diagram illustrating a data structure of map data;

FIG. 2 is a diagram illustrating a data structure of an integrated file;

FIG. 3A is a diagram illustrating links which have a same attribute and which are separated by a central median;

FIG. 3B is a diagram illustrating road management information according to a related art;

FIG. 3C is a diagram illustrating road management information according to one embodiment;

FIG. 4 is a diagram illustrating a relationship among a road management information list, a road name ID list and name dictionary data; and

FIG. 5 is a block diagram illustrating a navigation apparatus.

### DETAILED DESCRIPTION OF EMBODIMENTS

Embodiments of the present invention will be described below with reference to the accompanying drawings.

[1. Map Data Outline]

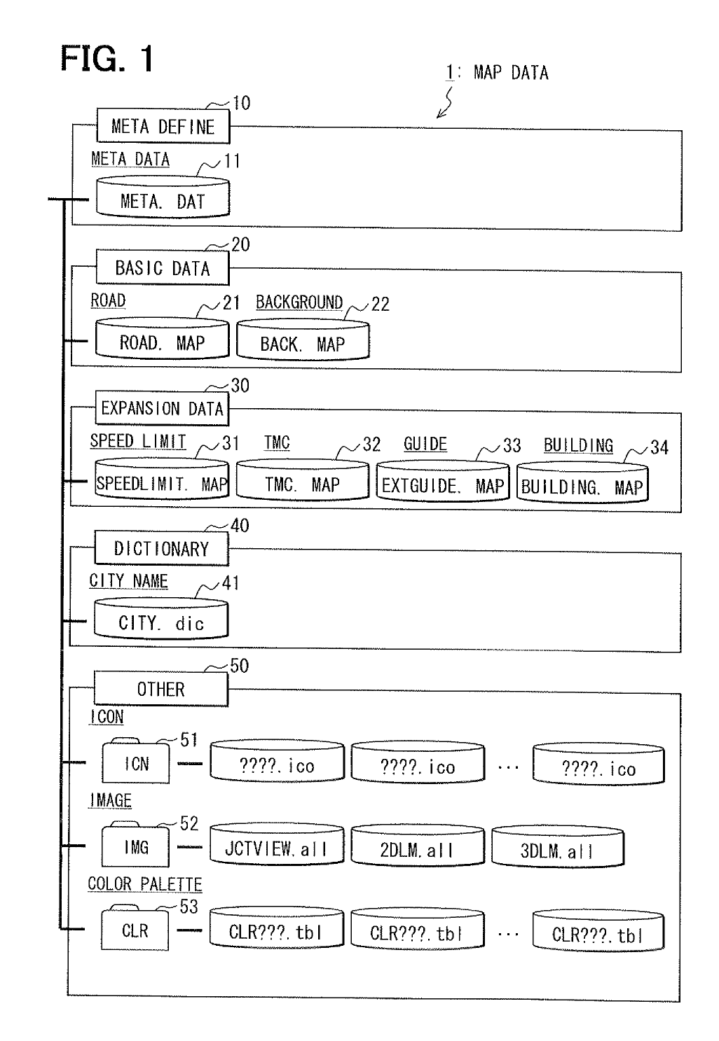

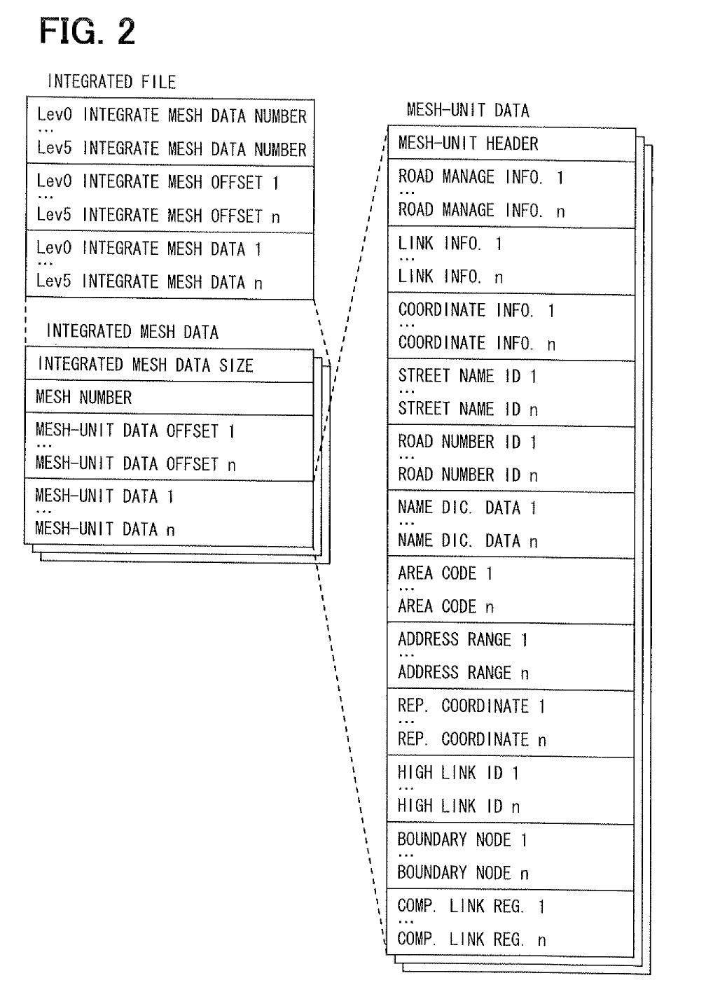

Map data 1 of the present embodiment will be described with reference to FIGS. 1 and 2. FIGS. 1 and 2 are diagrams illustrating a basic structure of the map data 1.

The map data 1 of the present embodiment has the following features.

(1) File Structure

Files included in the map data 1 are classified into meta definition data 10, basic data 20, expansion data 30, dictionary data 40, and other data 50. As shown in FIG. 1, the meta definition data 10 includes meta data 11. The basic data 20 includes road data 21 and background data 22. The expansion data 30 includes speed limit information 31, TMC (traffic message channel) information 32, guidance and lane information 33 and building and landmark information 34. The dictionary data 40 includes city name dictionary 41. The other data 50 includes icon definition 51, image definition 52 and color palette definition 53.

The meta data 11 stores structure information of record data. The road data 21 stores information about road networks. The background data 22 stores information about background in terms of, for example, plane, line, point or the like. The speed limit information 31 stores information about speed limit. The TMC information 32 stores information about TMC (traffic message channel). The guidance and lane information 33 stores information about guidance and information about lane. The building and landmark information stores information about building and information about landmark. The city name dictionary 41 stores information about city name in a dictionary format. The icon definition 51 stores information about icon. The image definition 52 stores information about image. The color palette definition 53 stores information about color palette.

(2) Mesh Structure

According degree of details, the map data 1 is generated and recorded on a level-by-level basis (from level 0 to level 5). In the map data 1, mesh data are organized in units of integrated mesh data. Each integrated mesh data is formed from integration of a reference mesh and surrounding meshes so that the number of surrounding meshes is level-dependent. The level 5 is the lowest degree of details and can act as wide-area data. The level 0 is the high degree of details and can act as detailed data.

(3) Integrated File Structure

The above-described basic data 20 and expansion data 30 (which include the road data 21, the background data 22, the speed limit information 31, the TMC information 32, the guide lane information 33 and the building landmark information 34) are organized in units of integrated file. Each integrated file is formed from integration of the integrated mesh data.

As shown in FIG. 2, the above-described integrated file includes: an integrated mesh data number list, which is a list of integrated mesh data numbers of respective levels; a integrated mesh offset list, which is a list of integrated mesh offsets of respective levels; and am integrated mesh data list, which is a list of integrated mesh data of respective levels. The integrated mesh data number of each level stores the number of integrated mesh data contained in the each level, and is 4 bytes in size. The integrated mesh data element number list, which has 6 integrated mesh data numbers for respective level, is 24 byte in size. The integrated mesh offset of each level stores an offset (byte location) to the integrated mesh data of the each level, and is 4 bytes in size. If the integrated mesh data of a certain level does not exist, the integrated mesh offset of the certain level stores a null value (0xFFFFFFFF). The integrated mesh offset list, which has 6 integrated mesh offsets for respective levels, is 24 bytes in size.

As shown in FIG. 2, each integrated mesh data includes integrated mesh data size information, mesh number information, a mesh-unit data offset list, and a mesh-unit data list. The integrated mesh data size information stores information on the total size of the integrated mesh data, and is 4 bytes in size. The mesh number information stores information on the number of meshes contained in a map region corresponding to the integrated mesh date, and is 2 byte in size. The mesh unit data offset list is a list of mesh unit data offsets 1 to n. Each mesh unit data offset “i” stores an offset (i) to mesh-unit data “i” (ii) from the beginning of the integrated mesh data of this level, where “i” is integer from 1 to n and each mesh unit data offset may correspond to one mesh. A mesh unit data offset stores a null value (0xFFFFFFFF) if a mesh corresponding to the mesh unit data offset does not exist.

Content of the mesh unit data varies depending on data types. Since the present embodiment relates to the road data 21, the road data 21 will be specifically described below.

(4) Road Data

Let us consider a case where the above-described integrated file forms the road data 21. As shown in FIG. 2, each mesh unit data, which is a portion of the integrated mesh data contained in the integrated file, includes a mesh unit header, a road management information list, a link information list, a coordinate information list, a street name ID list (referred to also as road name ID list), a road number name list, name dictionary data (referred to also as city name dictionary), an area code list, an address range information list, a representative coordinate information list, an upper level link ID list, a boundary node number list, and a composite link regulation record list.

The mesh-unit header stores the number of records (i.e., elements) in each of the lists (e.g., the road management information list) contained in the mesh-unit data. Each data contained in the mesh unit header is fixed-length. Thus, the mesh unit header itself is fixed-length.

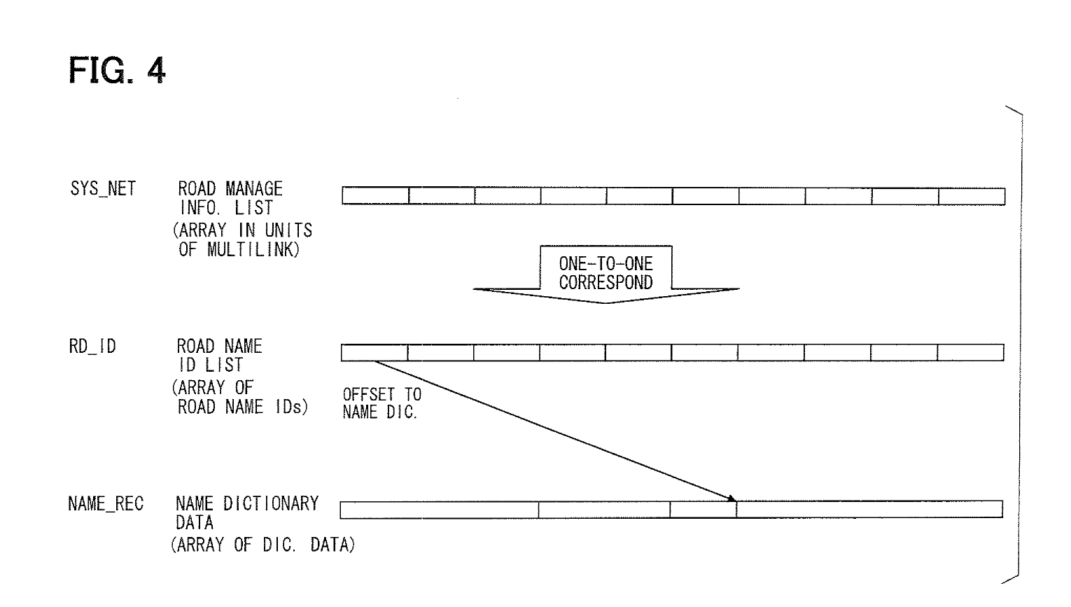

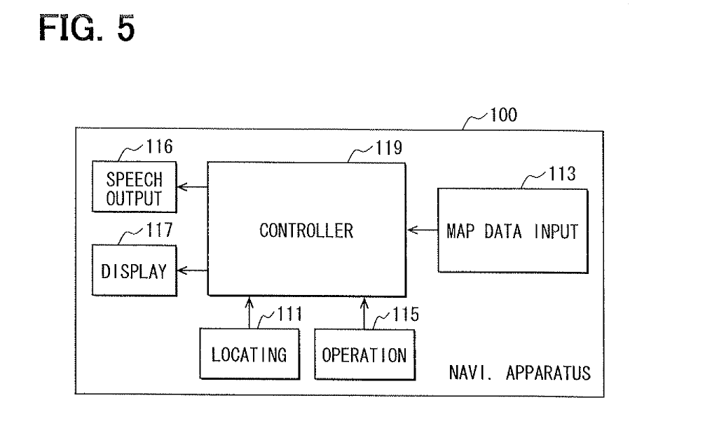

The road management information list stores fixed-length road management information elements, as shown in FIG. 4. The road management information elements respectively correspond to multilinks. Herein, the multilink is a group of links having the same attribute. In the present embodiment, it is assumed that the multilinks are defined based on multiple groups of continues links, each group having the same road name. Each road management information element indicates the number of links contained in a corresponding one of the multilinks. In the road management information list, the road management information elements are arranged in a given (predetermined) order called a multilink storage order. In the above, the road management information list is an example of a multilink information list. The road management information elements, are examples of multilink information elements.

The link information list is a list of link information elements. The link information elements respectively correspond to links. Each link information element is fixed-length and indicates the number of coordinate points that are set on a corresponding one of the links to indicate shape of the corresponding one of the links. The link information elements in the link information list are organized into multiple groups of link information elements so that the multiple groups respectively corresponds to the road management information elements. In the link information list, the link information elements are arranged so that the multiple groups of link information elements are arranged in the same order as the road management information elements are arranged in the road management information list.

The coordinate information list is a list of fixed-length coordinate information elements, each indicating a coordinate point that is set on a link to indicate position and shape of the link. The coordinate information elements are divided into multiple groups that respectively correspond to the link information elements in the link information list. Each group of coordinate information elements corresponds to one link. In the coordinate information list, the groups of coordinate information elements are arranged in the same order as the corresponding link information elements are arranged in the link information list. In each group, the fixed-length coordinate information elements may be arranged in an order in which the corresponding coordinate points are set on the link.

The road name ID list is a list of fixed-length offset information elements (also called road name ID elements) which respectively correspond to the road management information elements in the road management information list. As shown in FIG. 4, the offset information elements are arranged in the road name ID list in the same order as the corresponding road management information elements are arranged in the road management information list. In the road name ID list, each offset information element indicates location of a certain road name information element in the name dictionary data, where the certain road name information element indicates road name of a road corresponding to the multilink represented by the road management information element. The road name ID list is an example of offset information list.

The road number name ID list is a list of fixed offset information elements which respectively correspond to the road management information elements in the road management information list. The offset information elements are arranged in the road number name ID list in the same array order as the corresponding road management information elements are arranged in the road management information list. In the road number name ID list, each offset information element indicates location of road number information in the name dictionary data, where the road number information indicates a road number of a multilink represented by the corresponding road management information element.

The name dictionary data is dictionary data about road names and road numbers. The name dictionary data stores the road name information elements each indicative road name of the corresponding multilink as well as the road number information. Together with the road number information, the road name information elements are stored and arranged in the name dictionary data in an order in which the corresponding road management element information elements are arranged in the road management information list, as shown in FIG. 4. That is, the name dictionary data stores the information elements, each of which is variable-length and contains (i) information indicating the number of characters and (ii) a character string. The name dictionary data is an example of road information list. The road name information elements are examples of road information elements of the road information list.

The area code list is a list of fixed-length area code information elements, which respectively correspond to multilinks, and each of which indicates a code number of an area of the corresponding multilink. In the area code list, the area code information elements are arranged in the same order as the corresponding road management information elements are arranged in the road management information list.

The address range information list is a list of fixed-length address range information elements which respectively correspond to the link information elements in the link information list. Each address range information element indicates a house number of a road represented by a corresponding link. In the address range information list, the address range information elements are arranged in the same order as the corresponding link information elements are arranged in the link information list.

The representative coordinate information list is a list of fixed-length representative coordinate information elements which respectively correspond to the links and thus the link information elements. Each representative coordinate information element indicates a representative coordinate point that is set on a corresponding link. The representative coordinate information elements are arranged in the representative coordinate information list in the same order as the corresponding link information elements are arranged in the link information list.

The upper-level link ID list is a list of fixed-length offset information elements that respectively correspond to the links and thus the link information elements. Each offset information element indicates location of a link in upper level associated with the corresponding link. The offset information elements are arranged in the upper-level ink ID list in the same order as the corresponding link information elements are arranged in the link information list.

The boundary node number list is a list of fixed-length boundary node number information elements, which indicate coordinate points set on ends of links. The boundary node number information elements are arranged in the boundary node number list in an order in which the coordinate points are set on the links.

The compound link regulation record list is a list of fixed-length compound link regulation record information elements each indicating the presence and absence of regulation of a compound link. The compound link regulation record information elements are arranged in the compound link regulation record list in an order in which the corresponding link information elements are stored in the link information list.

The above map data is applicable to a navigation apparatus. A navigation apparatus 100 of the present embodiment will be described below with reference to FIG. 9. As shown in FIG. 9, the navigation apparatus 100 includes a locating device 111, a map data input device 113, an operation device 115, a speech output device 116, a display device 117, and a controller 119. The locating device 111 locates the present position of the vehicle equipped with the navigation apparatus 100. The locating device 111 includes, for example, a gyroscope, a distance sensor, a GPS receiver and the like.

The map data input device 113 includes a hard disk drive, which can act as a computer readable storage medium storing therein the map data. The map data input device 113 can input the map data to the controller 119.

The operation device 115 allows use's instructions to be inputted to the controller 119. The operation device 115 includes a touch sensitive panel provided on the display device 117, a group of operation switches provided on a body of the navigation apparatus 100 or a remote controller, or the like. Via the operation device 115, a user can conduct various operations on the navigation apparatus 100 such as map scale change, map scroll, destination designation, and the like.

The speech output device 116 includes a speaker and the like, and outputs guidance speech or the like upon receiving a signal from the controller 119. The display device 117 can provide full-color display. The display device 117 superimposes a present position mark indicative of the present position of the vehicle detected by the locating device 111, a navigation and the like on a map image made based on the map data inputted from the map data input device 113.

The controller 119 includes a CPU, a ROM, a RAM, an I/O and a bus line connecting the foregoing components. The controller 119 may be configured as a known microcomputer. In the controller 119, the CPU performs various processes to implement navigation functions in accordance with programs stored in the ROM.

For example, the controller 119 performs a drawing process to display a map on the display device 117, a route retrieval process to retrieve a navigation route to a destination designated by a user via the operation device 115, and a route guidance process to conduct guidance of a road, a facility and the like along the navigation route.

<2. Acquisition of Road Name Using Map Data>

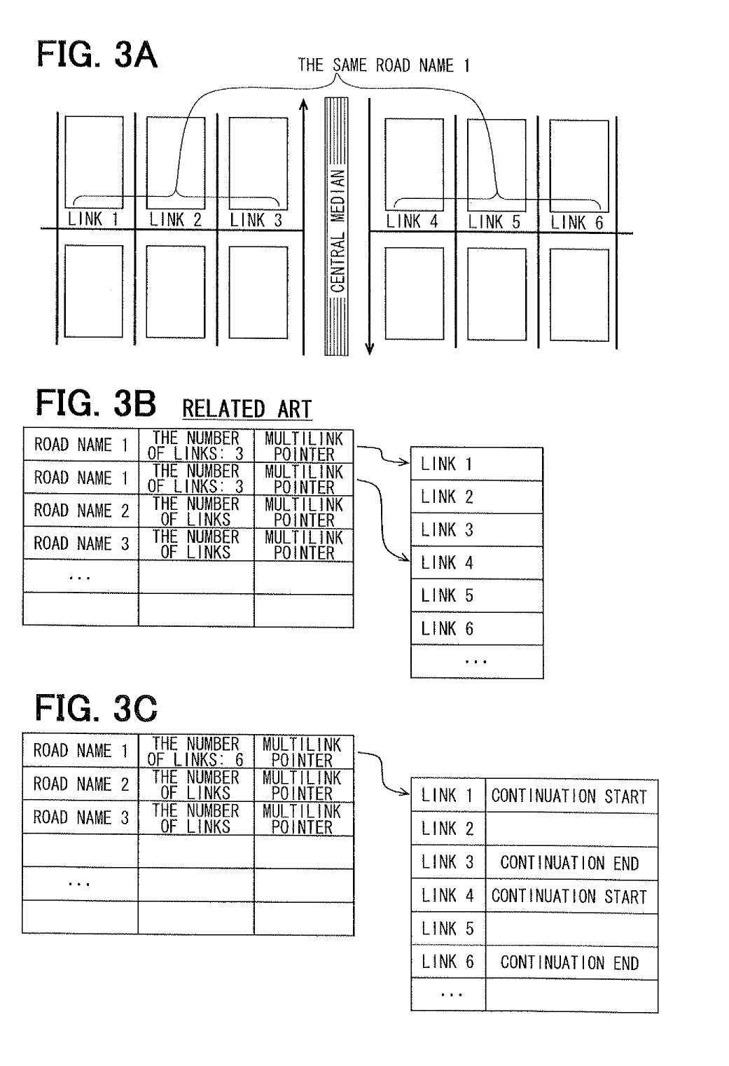

The navigation apparatus 100 utilizes the map data 1 to perform a navigation operation incusing various processes such a route retrieval process, a map drawing process and the like through reading the map data from the map data input device 113. In performing the various processes, the navigation apparatus 100 acquires a variety of information such as road name and the like from the map data 1. In the following, a road name acquisition process using the map data 1 will be described with reference to FIGS. 3 to 4. FIGS. 3 and 4 are diagrams illustrating a manner of acquiring a road name from the map data 1.

In the above road management information list (multilink information list) of the present embodiment, when multiple groups of continuous links are associated with the same road information element and have the same road name (see FIG. 3A, the multiple groups of continuous links are collectively prescribed as the same multilink (see FIG. 3C). This arrangement is different from that of the related art (see FIG. 3B). Moreover, as shown in FIG. 4, the road management information elements of the road managmagment information list have a one-to-one correspondence to the offset information elements of the road name ID list, which indicate offsets to data of the name dictionary data. Because of the above data structure, the controller 119 of the navigation apparatus 100 can acquire a road name ID element, which corresponds to a multilink and a road management information elements of the road management information list, from the road name ID list, and can identify location of the road name information element in the name dictionary data and acquire a road name indicted by the road name information element.

[3. Advantage]

According to the map data 1 of the present embodiment, in the road management information element, roads having the same road name are collectively expressed as one multilink (i.e., the same multilink). In other words, the links having the same attribute are not at separate locations but are collectively defined as one multilink (i.e., the same multilink). Thus, in extracting links having the same attribute, it is not necessary to search another location after one multilink at one location is extracted. Therefore, the map data 1 enables high speed access to data.

[4. Other Embodiments]

Embodiments of the present invention are not limited to the above-described embodiments. Examples of other embodiments will be described below.

(1) In the above road management information list, roads are organized into multilinks based on road names so that a group of roads having the same road name corresponds to one multilink.

(1-1) Alternatively, roads may are organized into multilinks based on road numbers so that a group of roads having the same road number corresponds to one multilink. In this case, the multilinks are prescribed in such manner that when one of the groups of links and another one of the groups of links are associated with the same road number, the one of the groups and another one of the groups are collectively defined as a same multilink. The road management information list is made so that the road management information elements correspond to the above multilinks.

(1-2) Alternatively, roads may are organized into multilinks based on road types so that a group of roads having the same road type corresponds to one multilink. In this case, the multilinks are prescribed in such manner that when one of the groups of links and another one of the groups of links are associated with the same road type, the one of the groups and another one of the groups are collectively defined as a same multilink. The road management information list is made so that the road management information elements correspond to the above multilinks.

(1-3) Alternatively, roads may are organized into multilinks based on road width so that a group of roads having the same road width corresponds to one multilink. In this case, the multilinks are prescribed in such manner that when one of the groups of links and another one of the groups of links are associated with the same road width, the one of the groups and another one of the groups are collectively defined as a same multilink. The road management information list is made so that the road management information elements correspond to the above multilinks.

In the cases of (1-1), (1-2) and (1-3) also, links having the same attribute are collectively defined as a same multilink so as not to be arranged at separate locations. Thus, in extracting links having the same attribute, it is not necessary to search another location after one multilink at one location is extracted. Therefore, high speed access to data becomes possible.

While the invention has been described above with reference to various embodiments thereof, it is to be understood that the invention is not limited to the above described embodiments and construction. The invention is intended to cover various modification and equivalent arrangements. In addition, while the various combinations and configurations described above are contemplated as embodying the invention, other combinations and configurations, including more, less or only a single element, are also contemplated as being within the scope of embodiment.

What is claimed is:

1. Map data in which roads are expressed in units of link and multilinks are defined based on respective groups of continuous links, each group having a same attribute, the map data comprising:
a multilink information list that stores therein fixed-length multilink information elements which respectively correspond to the multilinks while the multilinks are prescribed in such manner that when one of the groups of links and another one of the groups of links have the same attribute, the one of the groups and the another one of the groups are collectively defined as a same multilink, wherein each of the multilink information elements indicates a number of links contained in a corresponding one of the multilinks, wherein the multilink information elements are arranged in the multilink information list in a multilink storage order;
a road information list that stores therein road information elements which respectively correspond to the multilink information elements and which respectively corresponds to the multilinks in such manner that each of the road information elements indicates road information of a corresponding one of the multilinks, wherein the road information elements are arranged in the road information list in an order in which the corresponding multilink information elements are arranged in the multilink information list; and
an offset information list that stores therein fixed-length offset information elements which respectively correspond to the multilink information elements and which respectively correspond to the road information elements in such manner that each of the offset information elements indicates location of a corresponding one of the road information elements in the road information list, wherein the offset information elements are arranged in the offset information list in an order in which the corresponding multilink information elements are arranged in the multilink information list.

2. The map data according to claim 1, wherein:
the attribute is road name.

3. The map data according to claim 1, wherein:
the attribute is road number.

4. The map data according to claim 1, wherein:
the attribute is road type.

5. The map data according to claim 1, wherein:
the attribute is road width.

6. A computer readable storage medium storing therein map data recited in claim 1.

7. A navigation apparatus comprising:
a map data input device storing therein map data recited in claim 1; and
a controller configured to read the map data from the map data input device to perform a navigation operation.
